(19) United States
(12) Patent Application Publication
(10) Pub. No.: US 2025/0329171 A1
(43) Pub. Date: Oct. 23, 2025

(54) Automobile tailing and surveillance detection system

(71) Applicant: Nnabike Ibe Okaro, Fontana, CA (US)

(72) Inventor: Nnabike Ibe Okaro, Fontana, CA (US)

(21) Appl. No.: 18/642,835

(22) Filed: Apr. 23, 2024

(51) Int. Cl. G06V 20/58

(52) U.S. Cl. CPC G06V 20/58

(57) ABSTRACT

The disclosure herein describes an automobile tailing and surveillance detection system. The system utilizes sensors and cameras positioned at all corners of an automobile and sends data about cars around and most importantly behind the automobile to an intelligent system, which converts the images using an optical recognition system to data elements that can then be processed using machine learning and artificial intelligence to determine if the automobile is being tailed.

### CROSS-REFERENCE TO RELATED APPLICATION 63/529,149

This application claims the benefit of priority under 35 U.S.C. § 119(e) of U.S. Provisional Application Ser. No. 63/529,149, filed Jul. 27, 2023, by Nnabike Okaro., entitled “AUTOMOBILE TAILING DETECTION SYSTEM,” which is hereby incorporated by reference in its entirety.

### TECHNICAL FIELD

This disclosure relates in general to the field of data sciences and electronic communications.

### BACKGROUND

Personal security is of concern to people. A lot of robberies and murders are carried out by individuals first being tailed. At times for days before they are attacked or robbed. As a result of this, it is crucial to monitor one's surroundings. This tailing and surveillance detection system enables the user to take preventive measures and thereby prevent any escalation.

### SUMMARY

The automobile which will contain this system will be herein referred to as “The automobile” and the tailing vehicle(s) will be referred to as “The tail”. The image recognition system is taught how to identify automobiles, their colors, people and plate numbers. The items categorized are then further analyzed to produce metadata elements such as plate number, car make and model as well as other characteristics.

In the event that there is no front plate number, it uses other identifying characteristics on the tail such as imperfections, stickers and other unique characteristics that can be seen on cars like vin tags.

The data that helps the system to determine tails include driving patterns, time, distance and synchronized movements of the automobile and the tail. The intelligent detection system can also support multiple tail detection. Whereby two or more cars Car A, Car B, Car C take turns to tail the automobile.

The Artificial Intelligent System (A.I.S) receives input data from the optical recognition components, which is composed of the cameras and image sensors. The data passed to the A.I.S consists of a series of snapshots. Each snapshot is composed of environmental data including car plate numbers, G.P.S coordinates of the snapshots, the time of the snapshot and the relative location of prospective tails in relation to the automobile. The Machine learning component is trained with multiple models. Each model is trained to predict driving behavior and movement of tails. and determines by the pattern the probability of a tail. Probability ranges from 0 to 1, with 0 being no chance of a tail and 1 being a strong certainty of a tail.

The system is designed in such a way that models can be updated, improved or upgraded to enhance detection and curb avoidance procedures by bad actors.

The Notification system can be a connection to various systems, including but not limited to An App, a security or police network or any alert system. It can connect to a secure API, which can allow other systems to subscribe to the alerts using a publisher/subscriber model. This enables clients to subscribe to alerts at different levels of prediction scores, which might be different than the default recommendation.

Every automobile that is identified is given an identifier ID and this ID is used to update the pattern of the identified automobile. Automobile identification can span hours or days depending on when the sampling window is set. Sampling window specifies the duration of time to check for tails and can be set to daily, weekly or monthly. This means that an automobile ID is discarded from the sample an hour, week or month after it is first detected provided it has not been established as a tail.

Criteria affecting tail probability are Lane changing, speed and flow of traffic, turn signal order or lack thereof. However, more detailed behavior can be taken into consideration for example, the direction of gaze of the tailing car's passengers. Features such as facial recognition are also taken into consideration in the case that the tail switches cars across several trips, in addition to the driving pattern, thus creating passenger identification, whereby passengers are given a temporary system generated ID within the sampling window.

A collection of manual criteria creates a rules engine. The rules engine can be tweaked manually to allow for more extenuating circumstances such as human behavior that the machine might not be suited to handle, and constantly improve it based on findings. In addition, the machine learning system takes the driving patterns and learns from them, allowing it to make predictions based on past training data.

### BRIEF DESCRIPTION OF THE DRAWING

FIG. 1 Depicts a block diagram of the system workings with cameras and sensors input through the Artificial Intelligence processing system, which then uses the CPU to store data from memory to the database, where the Machine Learning system gets the data to compare with learning models that have been trained to identify tail patterns and also run pre-programmed rules to display only potential tails to the alert system.

FIGS. 2-2C Illustrates the system in snapshots of a simulated real world environment, showing the movement of cars around the automobile equipped with the tailing system.

FIG. 3 is a workflow representation diagram of the decision making structure of the Artificial Intelligence System after it has been supplied with a detected image.

FIG. 4A-4B Shows the Facial recognition system FIG. 4A and the Automobile recognition system FIG. 4B identifying unique features on the vehicle or human face.

### DETAILED DESCRIPTION

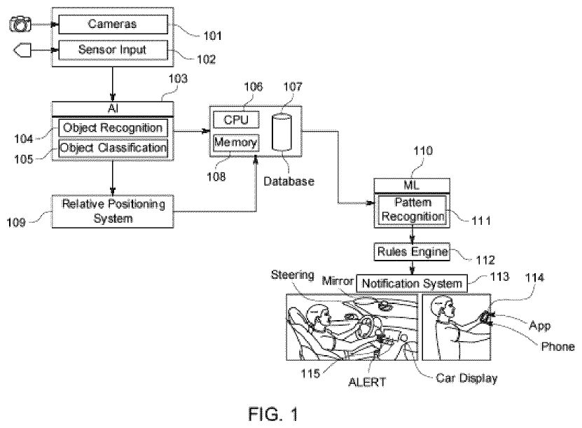

In FIG. 1, the sensor input 102 detects an object. Various types of sensors can be utilized such as Light Detection And Ranging (LIDAR), Sound Navigation And Ranging (SONAR) or Portable Radio Detection And Ranging (RADAR) Infrared Sensors (IR), The LIDAR sensor as an example in this scenario emits light photons or pulsed light waves from lasers, which can help calculate distance by using the time it takes to return to the detection apparatus. The distance and location of the detected object can be arrived at by the time and direction the light from the LIDAR is sent.

The sensor activates the cameras 101 to capture the image at the location detected. The images captured are then transmitted to the AI system 103, which attempts to classify the object and also determine its relative coordinates using the Relative Positioning System 109. For objects that the system is interested in, for example automobiles, trucks and so on, the AI system 103 extracts relevant metadata, such as color, license plate number, make and model of the car and other identifying characteristics and then the information is sent to the Central Processing Unit (CPU) 106, that stores the data in Memory 108, and then transfers this data to Database 107.

For all unique automobile objects stored in the database, every instance of it is monitored by the Machine Learning (ML) system 110. The pattern of movement of every detected automobile is monitored by the pattern recognition system 111. The data sent to the Pattern recognition system, which consists of trained ML Models, enables the ML system to learn from every dataset that is sent to it. The ML system learns from data acquired by Automobiles that are and are not tails. The system then gives the automobile a score and passes the information to the rules engine 112, which compares the data accumulated so far with sets of predetermined rules in the system. Rules in the Rules Engine are human input instructions that, if matched, increases the probability score that is passed in from the pattern recognition system.

Automobiles with scores that exceed a certain threshold score are then passed on to the Notification System 113. Notification system pushes alerts to either a car display 115, an app 114 or any system that has access to an authorized Application Programming Interface (API), which can also be another API or another system.

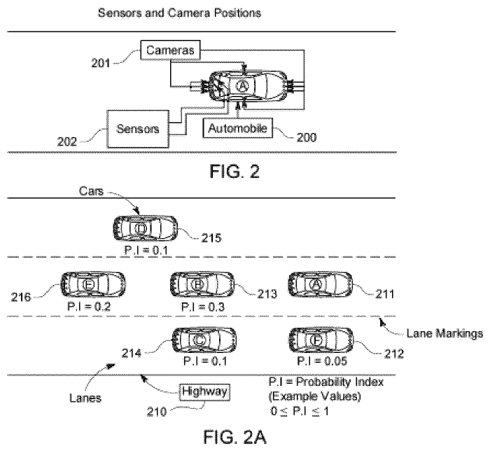

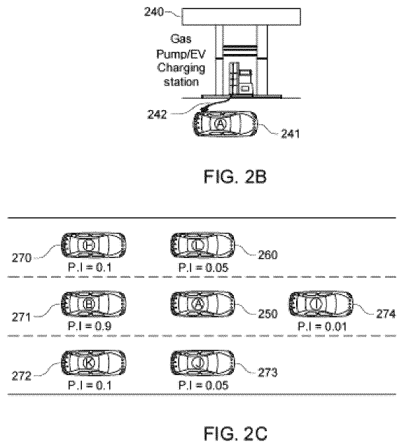

FIG. 2 is an illustration of a car 200, labeled Automobile “A”, equipped with the invention, the automobile tailing detection system. 201 represents cameras positioned at different points around the car and 202 represents sensors also positioned at different points around the car. In FIG. 2A Automobile A is depicted on the highway with other automobiles behind and next to it. The sensors detect the cars and track them. Immediately behind Automobile A, is Automobile B, labeled 213 and in this example, the system generates and assigns it a score, which is a mathematical probability index (P.I) of 0.3. Next to Automobile A is Automobile F, labeled 212 assigned a P.1 of 0.05, behind Automobile F is Automobile C, labeled 214 and assigned a P.I of 0.1. Automobile E, labeled 216 is behind Automobile B and is assigned a P.I of 0.2, and next to 216 is Automobile D labeled 215 and assigned a P.I of 0.1. In FIG. 2B, Automobile A stops at a Gas pump/Electric charging center 240, to refill. In FIG. 2C, Automobile A is back on the highway and is now behind Automobile I, labeled 274 with a P.I of 0.01, and 271 with a P.1 of 0.9, which has gone up from 0.3 as it has re-occurred behind Automobile A, despite the unique path and stops made by Automobile A. 270, 272, 260 and 273 have low P.I's as they are newly detected by the sensors and cameras.

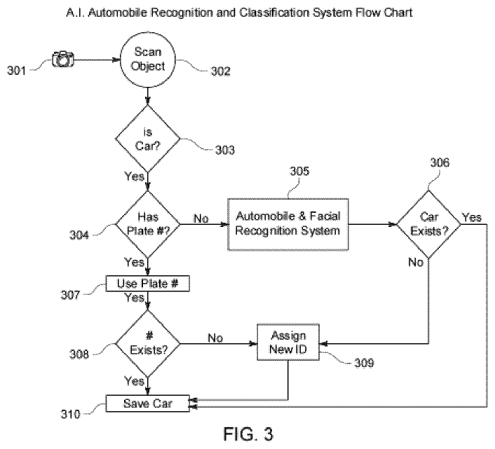

In FIG. 3, the flow chart shows the logical workflow the system uses to uniquely identify Automobiles as soon as they are detected. 301 shows a camera which is used to take snapshots of detected objects around the car. When an object is detected and input into the system by means of 301, the Artificial Intelligence System (A.I.S) attempts to categorize it. If the object is a car or automobile that has been pre-programmed as a type that can be a tail, the workflow continues, or else it aborts. When an automobile 303 has been detected and scanned, the system checks for a plate number 304, if one is detected, the A.I.S attempts to read the plate number, the plate number is then read and a unique ID is assigned to the Automobile. If at 304, no plate number is detected or at 307, the plate number is illegible for any reason, the A.I.S uses the Automobile and Facial Recognition system and at 308 and 306, if the car does not already exist in the system, a new unique identifier is created 309, if the automobile already exists in the system then it's information such as current relative position is updated in the system.

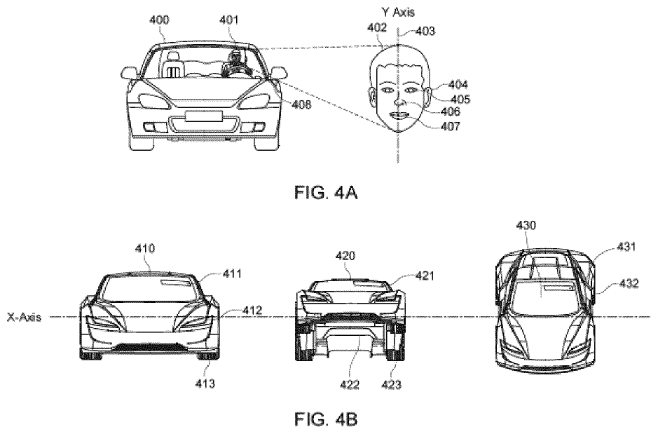

FIG. 4 A shows an automobile 400 that has been scanned into the system. It shows an individual 401 seated in the driver's side. 402 shows the face of the driver captured by the system. Distinguishing characteristics such as 404, 405, 406 and 407. In addition to the facial recognition system, FIG. 4B illustrates how the A.I.S uses the automobile recognition system to uniquely identify the vehicle to save. Distinguishing characteristics on the vehicle are noted such as bumper stickers and decals as seen by 411 in image 410. 420 shows the same automobile at a different camera angle, rotated along the x-axis. 422 is the under-carriage of the automobile which can add to the set of images to uniquely identify the automobile. 421 also shows the same decal which is also identified by 431 in a different perspective in 430 rotated along the x-axis in the opposite direction.

A combination of the Automobile recognition AND the passengers Facial recognition can produce a more precise probability score.

### REFERENCES CITED

### Publication #Priority Date Publication Date Assignee Title

U.S. Pat. No. 10,540,564B2 2018 Jun. 20 2020Jan. 21 Blinker Inc Method and apparatus for identifying vehicle information from an image
U.S. Pat. No. 6,947,579B2 2002 Oct. 31 2005 Sep. 20 Intel Benelux BV Three-dimensional face recognition
DE102015215561A1 2015 Aug. 14 2017 Feb. 16 Conti Temic Microelectronic GmbH Vehicle camera device for receiving an environment of a motor vehicle
FI123982B 2009 Oct. 9 2014 Jan. 15 Visidon Oy Face recognition in digital images
JP6102213B2 2012 Nov. 22 2017 Mar. 29 Fujitsu Ltd Image processing apparatus, image processing method

1. A system by which car movement patterns are deciphered to strongly detect that it is a tailing car, which is Computed from input data sent by visual input devices and/or cameras around the cars, subsequently then transferred to the system, to analyze the driving pattern of each car whereby its relative positioning is used to map movement patterns that is then interpreted by the processor to determine if it is a tail.

2. The method of claim 1 further comprising a device with sets of rules to improve accuracy, when pre-programmed elements such as the automobile owner's office or home are in the system and pit stops, it increases the probability index when a car or cars following the same destination pattern are discovered.

3. The method of claim 2, further comprising both automobile recognition and facial recognition wherein uniquely distinguishing characteristics of the car are used to uniquely identify it.
